(19) United States
(12) Patent Application Publication
(10) Pub. No.: US 2017/0283238 A1
(43) Pub. Date: Oct. 5, 2017

(54) Liquid Dispenser Appliance

(71) Applicant: Nicole Elder Hawkins, Cumberland, RI (US)

(72) Inventor: Nicole Elder Hawkins, Cumberland, RI (US)

(21) Appl. No.: 15/089,718

(22) Filed: Apr. 4, 2016

(51) Int. Cl. B67D 3/00

(52) U.S. Cl. CPC B67D 3/0067; B67D 3/0096; B67D 2210/00097

(57) ABSTRACT

Liquid dispensing appliance for use with a bladder bag equipped with a nozzle and containing a liquid in varying volumes, for example wine, tea, juice or water that is currently sold in bags of varying volumes. The appliance consists of 2 pieces—1 body comprising of a top panel, 2 side panels, a front panel and a back panel and the 2^{nd} piece a removable sliding tray sized to mate with the body. The sliding tray is configured to engage the nozzle thus locking the bag and tray in place. The sliding tray is positioned at an upward angle to aid in the flow of the liquid towards the nozzle. The tray also consists of a hole in the bottom for ease of removal for loading and unloading the bag. The front panel has a concave recess configured to engage the top part of the nozzle. The back panel consists of a wide slot for use as a handle. The appliance may also come with decorations.

### CROSS REFERENCE TO RELATED APPLICATION

This application claims the benefit of U.S. Provisional Application No. 62/253,966 filed on Nov. 11, 2015, entitled “Liquid Dispenser Appliance”. The patent application identified above is incorporated here by reference in its entirety to provide continuity of disclosure.

### FIELD

A liquid dispenser appliance for dispensing fluids contained in bladder bags with attached nozzles is disclosed herein.

### BACKGROUND

This invention provides an appliance to hold and dispense a liquid that is in a sealed plastic bag containing a liquid dispensing nozzle. This invention will create an appliance that looks like a kitchen/bar appliance made to dispense the liquid. The bag of liquid can be transferred to the appliance in a novel fashion and set on a counter, table or in the refrigerator where the liquid can be easily dispensed.

The need for this invention is due to the recent development of plastic bag liquids being sold at stores in cardboard boxes. The cardboard boxes are designed to transport the bags safely, create easily stackable displays and provide a point of sale marketing presentation for the liquid. They are customarily designed with a tear off or fold out flap to allow the consumer to expose the nozzle so the liquid can be dispensed. They are not designed for general use, the flaps, glue and folded corners of cardboard are not strong enough for repeated mechanical jostling of the many pounds of liquid. They also make it difficult to properly maneuver the nozzle. And lastly, due to their commercial function they are not designed for residential display. The long lasting nature of liquid bag storage creates a scenario where the consumer essentially displays an advertisement for the liquid within the home for weeks at a time. There is a need for a durable, reusable liquid appliance. There is a need for an easy to load dispenser and there is a need for an appliance that belongs on a countertop and is not a marketing display.

There are several earlier inventions for dispensing bagged liquids that focus on the cooling, carrying and supporting bagged and/or boxed liquids. These inventions show familiar aspects for the purposes of housing a liquid dispenser of the box or bladder form but they are complicated, have expensive components and are not appropriate for residential display. The novelty of this invention is the ease of transferring a bagged liquid to an appliance that is designed to replace the cardboard box with an attractive dispenser for residential and commercial use.

The simplicity of the design makes it less expensive to produce and more appropriate for home owners and small businesses. This invention does not incorporate any mechanical devices needed to make the dispenser work. The sliding removable tray allows for the bagged liquid to be easily inserted in the dispenser and locks the nozzle of the bagged liquid in place after returning the tray into the dispenser.

U.S. Pat. No. 8,800,814 to Braun et al discloses a dispenser that incorporates a spring to force the wine that remains in a boxed liquid dispenser to be dispensed from the invention. U.S. Pat. No. 8,777,059 to Middleton discloses a liquid dispensing system that uses springs to force the liquid upwards to the nozzle that is positioned at the top of the dispenser. In this design, the liquid would not dispense without the spring loaded plate. There is a need for dispensers without complicated mechanisms and loading methods.

U.S. Pat. No. 6,334,329 to Weller discloses a wine box cooling apparatus that is designed to hold a box and an ice block for cooling purposes. The design allows for a specific size of box whereas boxed beverages come in all different sizes and shapes. There is a need for dispensers that accommodate all boxed liquids to be dispensed by removing the bladder bag from the cardboard box and placing it in the dispenser. Bladder bags are malleable and can take on different shapes once removed from their containers.

U.S. Pat. No. 8,430,284 to Broadbent et al discloses an insulated carrier for bulk beverage containers such as wine boxes. There is a need for stationary appliances that dispense liquid without power or insulation. The apparatus can be stored in a refrigerator for cooling purposes or put on a countertop for the liquid to be served at room temperature, the liquid can be iced after being dispensed from the invention.

U.S. Pat. No. 7,646,567 to Crossley et al also discloses an apparatus for cooling and dispensing wine from a wine filled bag of a prepackaged wine box. This apparatus comprises a box housing a bag and suggests several ways for cooling the liquid inside the box. There is a drip reservoir on the front face to catch wine that drips and a nameplate can be placed on the front to show the identification of the wine inside the box. There is a large base. There is a need for dispensers that allow for the bag of liquid to be easily place into the bottom of the box by removing a sliding tray and then sliding back into place locking the bag in the box. The removable sliding tray also is placed at an angle to help the bag of liquid dispense through gravity. The present invention's bottom loading novelty allows for the apparatus to better fit in with kitchen appliance appearances by not having a base, marketing nameplates, carrying straps, insulation, etc.

U.S. Pat. No. 9,095,201 to Simonsen discloses an expandable insulated boxed wine carrier. The abstract describes an expandable carrier to accommodate differing sizes of boxed wines and includes shoulder straps for carrying the apparatus around.

### SUMMARY OF THE INVENTION

The invention creates a durable, easy to use and appealing solution that replaces the cardboard boxes that dispense a liquid in a bag. Boxed liquids will improve their utility if the liquid can be transferred to a durable functional aesthetic dispenser. This invention can be used in residential and commercial settings where consumable liquids are served.

This invention has utility for the many products that are currently sold in box/bag form. It is a growing trend and many more producers of drinkable liquids will be selling their products in this manner due to the ease of use and the extended shelf life that sealed bladder bags offer consumers. Due to boxed liquids being sold in different shaped boxes and volumes, the design of this invention accommodates bags of varying sizes and different size nozzles. The non-rigid form of the liquid bag can contort to the shape of the appliance. The invention therefore is advantageous in that it does not have to accommodate the many shapes and sizes of the cardboard boxes being sold on the market, rather it accommodates all the bags within the boxes being sold.

The invention can be made with any material eg. Wood, metal, plastic, ceramic, glass, or composites of the aforementioned materials. A preferred embodiment of wood for example would be stained to match the cabinets, trim or counter material of the kitchen/bar. A preferred embodiment of metal would be stainless steel to match the stainless steel appliances of the kitchen/bar. A preferred embodiment of plastic would be rigid formed or molded materials such as polycarbonate, ABS or polyolefins that are in a color to match the appliances of the kitchen/bar etc.

### DESCRIPTION OF THE FIGURES

FIG. 1 is an isometric representation of the appliance.

FIG. 2 is a representation of a liquid bag being loaded into the appliance body.

FIG. 3 is a representation of the sliding tray slid in place in the appliance body.

FIG. 4 is a representation of the back wall of the appliance.

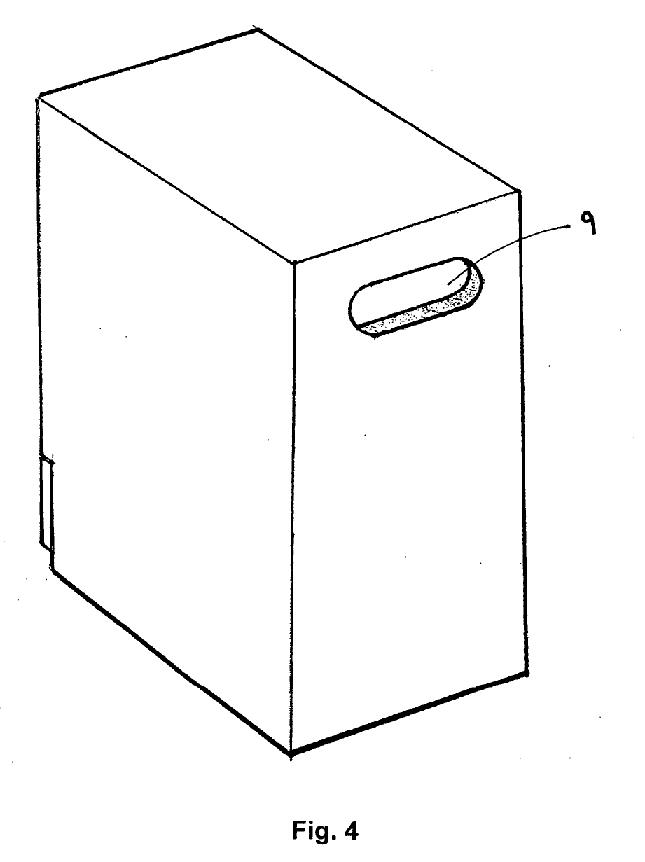

FIG. 5 is a representation of the appliance on a residential countertop.

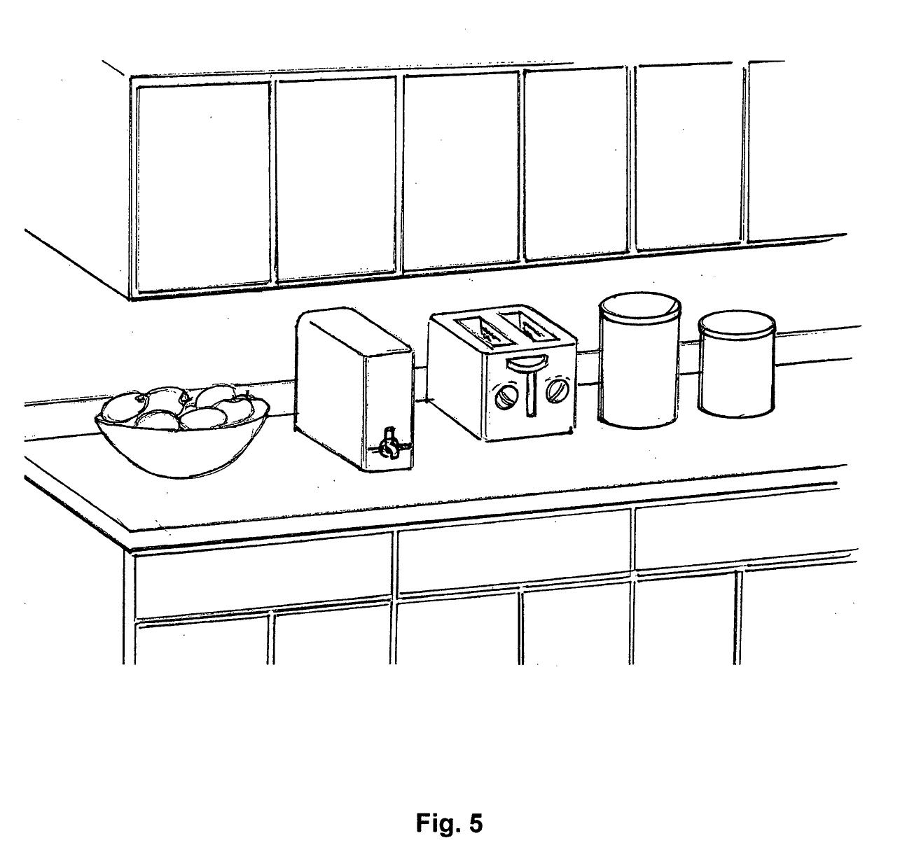

### DESCRIPTION OF THE INVENTION

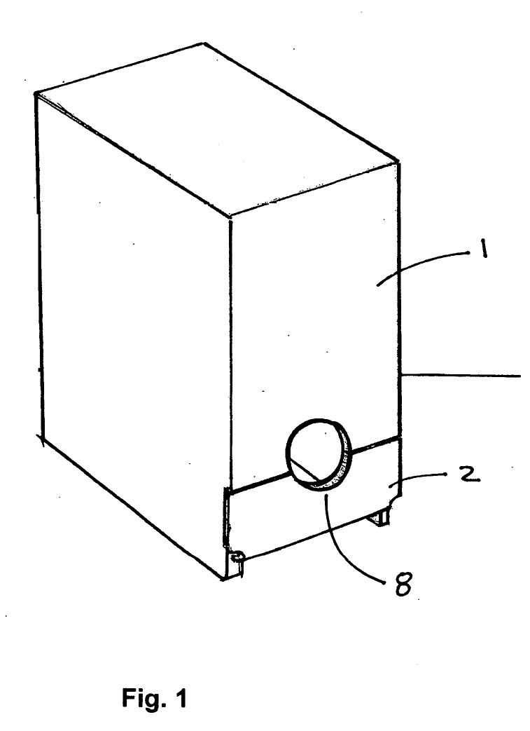

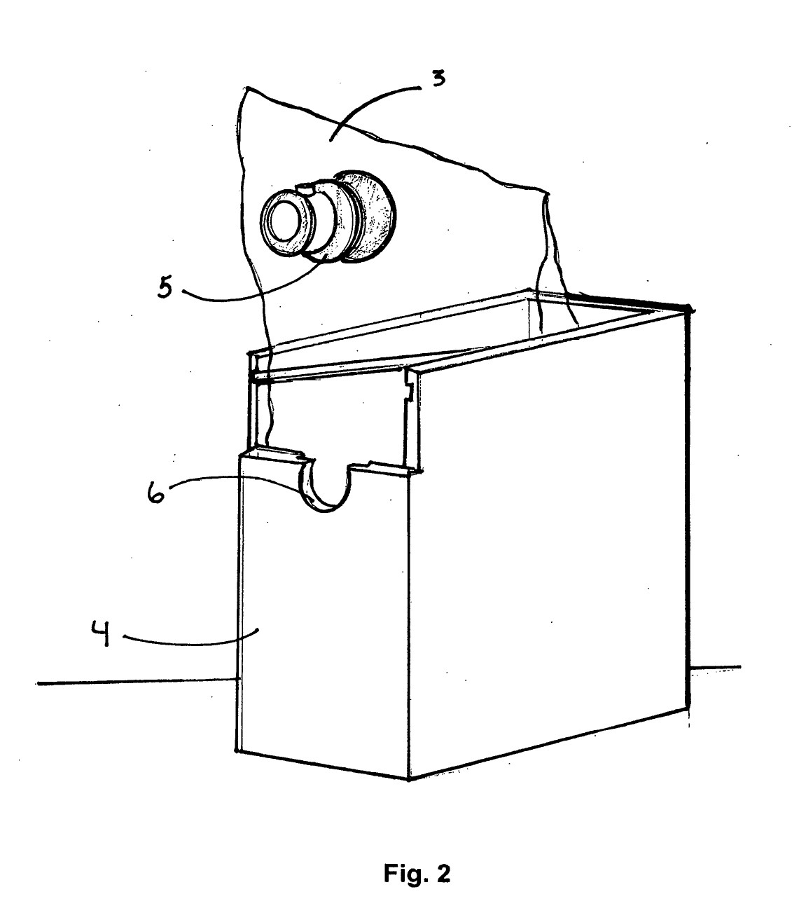

The invention is comprised of two items as seen in (FIG. 1), an appliance body 1 and an appliance tray 2. The appliance body is composed of five walls, front, back, top and two sides. The body is preferably sized with an internal volume to accommodate commercial liquid bladder bags. Preferably between 0.75 and 6 liters or 45.8 in³ and 366.2 in³. This size is also preferable to fit on residential counter tops. In a novel action of the invention, the tray is removed by pulling it out of the body and the entire body is then turned upside down (FIG. 2). After removing the bag of liquid 3, from its original container, the bag is dropped down through the bottom of the appliance 4.

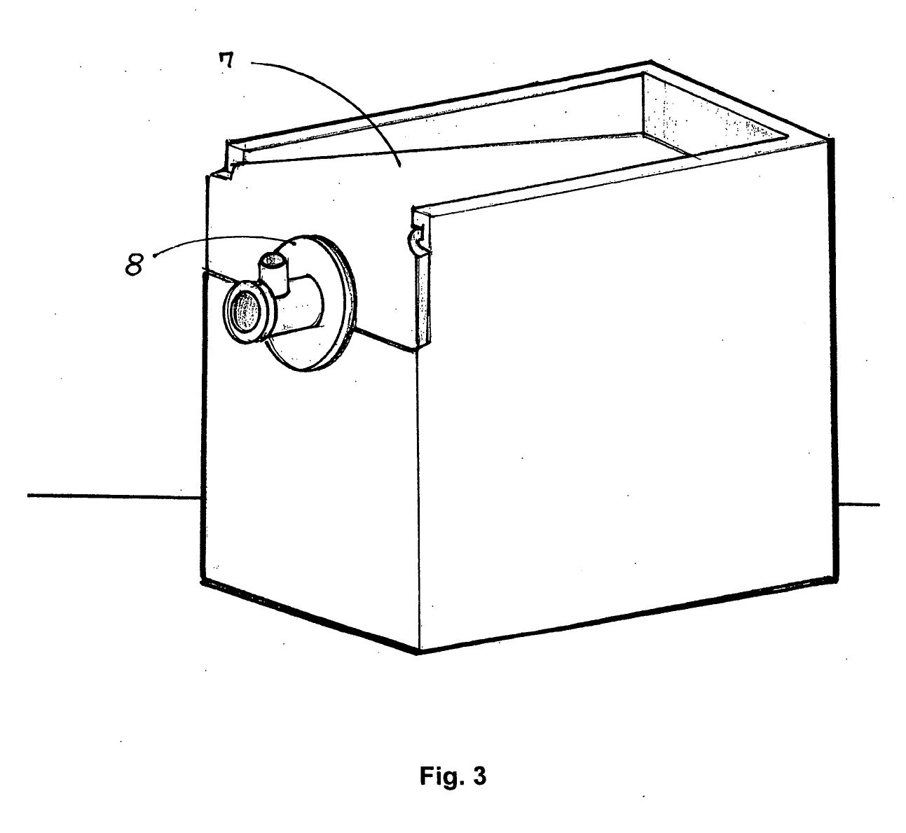

The neck of the nozzle 5, is nestled into the concave receiving portion 6, on the front wall of the appliance body. The tray is then slid back into place locking the nozzle and holding the bag inside (FIG. 3). The action of the receiving portion 6 is such that it retains the nozzle from motion in three directions, anteriorly away from the front wall, posteriorly towards the back wall, and superiorly towards the top wall. The nozzle is free to move inferiorly or superiorly away from the open bottom. The addition of the tray stops this final degree of freedom and captures the nozzle and liquid contents in a simple one step action that does not require a secondary locking mechanism. During use, the main portion of the tray 7, supports the weight of the liquid as the appliance body is bottomless. In a preferred embodiment, the front portion of the tray 8, contains a retention feature to inform the user of the proper assembled location of sliding tray 2. The feature 8 can be a concave shelf, a flat bump, a molded ridge etc. The feature 8 combined with receiving portion 6 completes the capturing of the nozzle. The weight of the bag on the tray and the fully captured nozzle keep the liquid contents stable during the transport and manipulation required for use. When the appliance is turned over again, however, the tray can be easily removed. The tray/nozzle/front wall assembly does not require a release button, a catch, a pin, a snap, a latch, or any additional user action.

The tray 2 preferably contains an indicating feature to inform the user of the appliance's contents. The tray can simply be of a color to match the contents of the liquid, i.e. red for red wine, white for white wine, etc. However this indicating feature can be a molded/fabricated icon such as a letter or word. It can be an opening or window such that the user can see the contents.

The side walls of the body contain mating features for the sliding action of the tray. In a preferred embodiment these are grooves or recesses in the walls that receive the edges of the tray. In a preferred embodiment the grooves traverse an inferior front to superior back pathway in order to aid gravity induced liquid dispensing. Those familiar with the art will contemplate alternative mating features for the sliding action; they would be tracks, “c” channels, linear slide bearings, toothed grooves, molded features, slots, or positive rails. Those familiar with the art will also contemplate that the sliding action of the tray could be side to side rather than front to back, that the grooves could be a slot on one side and a shelf on the other, they could be additionally located on the front and back walls, or any combination therein.

The body 1 can then be turned back over and is ready to dispense its contents. The handle #9, for the appliance is preferably a recess located on the back wall of body 1. This allows the handle detail to remain unseen in normal use. The recess can also be used as a catch surface for wall mounting the body. The use of a recess handle rather than a positive feature or additional feature is preferable for the simplicity of the present invention, however, molded handles, leather handles, strap handles, clips, grips and no handle are also envisioned.
the handle can be used to carry apparatus to other areas of a home or restaurant/bar
the handle can be used to tilt the apparatus to dispense the last portions of the bagged liquid
commonly used in residential kitchens and restaurants such as wood, metal, and plastic
may also be comprising of adornments such as stickers, charms including wine glass signets and decorations that may be applied prior to or after ownership.

What is claimed:

1. An appliance for dispensing variable size bladder or bag liquids with nozzles comprising:
An enclosure with an interior volume adequate to hold commercially available bladder bags of liquid, and a tray.
Said enclosure has fixed front and back walls.
Said enclosure has a fixed top wall.
Said enclosure has fixed side Walls with grooves for receiving the tray.
The front wall containing a receiving portion to partially capture a bladder nozzle.
Said tray is a removable sliding tray that traverses the grooves in the side walls and whose front portion secures the nozzle and whose main portion supports the bag of liquid inside the appliance.

2. The appliance of claim 1, where the tray further contains a feature to indicate the type of liquid within the appliance.

3. The appliance of claim 1, where the side panel grooves traverse a front inferior to back superior pathway.

4. The appliance of claim 1, where said removable tray has a retention feature to engage the bags nozzle.

5. The appliance of claim 1, where the back panel further incorporates a recess for the purpose of a handle

6. The appliance of claim 1, where the enclosure materials specifically match the materials of the appliance use location.

7. The appliance of claim 1, where the enclosure materials specifically match the color of the appliance use location.

8. An appliance for dispensing variable size bladder or bag liquids with nozzles comprising:
An enclosure with an interior volume adequate to hold commercially available bladder bags of liquid, and a tray.
Said enclosure has fixed front and back walls.
Said enclosure has a fixed top wall.
Said enclosure has fixed side walls.
The front wall containing a receiving portion to partially capture a bladder nozzle.
Said tray is a removable tray and whose front portion secures the nozzle and whose main portion supports the bag of liquid inside the appliance.

9. The appliance of claim 8, where said tray slides in grooves located on said enclosure walls.

10. A method for loading a liquid dispensing appliance whereby a bottomless appliance is turned upside down, a bag containing liquid is transported through the bottom portion and secured with a sliding tray.

11. The method of claim 10, further including nestling a nozzle on the bag containing liquid into a receiving portion on the front wall of the liquid dispensing appliance, And whereby securing with a sliding tray does not require secondary actions.
